(19) United States
(12) Patent Application Publication
(10) Pub. No.: US 2026/0331848 A1
(43) Pub. Date: Oct. 22, 2026

(54) HIGH POWER CONNECTOR

(71) Applicant: BIZLINK INTERNATIONAL CORP., New Taipei City (TW)

(72) Inventors: Chubei ZHANG, New Taipei City (TW); Xiangwu WANG, New Taipei City (TW)

(21) Appl. No.: 19/181,028

(22) Filed: Apr. 16, 2025

(51) Int. Cl. H01R 24/30; H01R 103/00

(52) U.S. Cl. CPC H01R 24/30; H01R 2103/00

(57) ABSTRACT

A high power connector includes a housing and three terminals. The housing includes a plurality of terminal holes. Each of the three terminals is inserted into a corresponding terminal hole. The three terminals respectively include in sequence a head portion, a connecting portion, and a tail portion. The head portions of the three terminals are inserted into the terminal holes for connecting to an external connector, and the connecting portions and the tail portions of the three terminals are exposed from a rear side of the housing. In addition, the three terminals include different offset distances between the tail portion and the head portion thereof.

### BACKGROUND

### Technical Field

The present disclosure relates to a connector. More particularly, the present disclosure relates to a high power connector.

### Description of Related Art

In the US patent US2023/0011560A1, a first connector and a second connector are disclosed. The second connector is configured to be connected with the first connector. The first connector has three terminal holes on its front end surface, each of the terminal holes is configured to allow a terminal of the second connector to be inserted therein. The first and second connectors are secured with each other by the latch and fixture formed on the outer surface thereof respectively.

### SUMMARY

One of the technical aspects of the present disclosure is to provide a high power connector for providing power to, for example, server rack. By extending the terminals to different offset distances, the terminals of the high power connectors may be conveniently and safely connected with the electrical wires.

According to an embodiment of the present disclosure, a high power connector including a housing and three terminals. In addition, the three terminals include different offset distances between the tail portions and the head portions of the three terminals. Furthermore, the high power connector according to some embodiments of the present invention can conveniently utilize in a server rack to provide more power with high current to the required electronic devices.

### BRIEF DESCRIPTION OF THE DRAWINGS

The disclosure can be more fully understood by reading the following detailed description of the embodiments, with reference made to the accompanying drawings as follows:

FIG. 1 is a schematic perspective view of a high power connector according to an embodiment of the present disclosure;

FIG. 2 is a schematic perspective view of the high power connector as shown in FIG. 1, in which the high power connector is connected to conductive wires through adapters;

FIG. 3 is a schematic perspective view of a plurality of high power connectors as shown in FIG. 1, in which the high power connectors are electrically connected to each other;

FIG. 4 is a schematic side view of the high power connector as shown in FIG. 1;

FIG. 5 is another schematic perspective view of the high power connector as shown in FIG. 1;

FIG. 6 is a schematic perspective view of a high power connector according to another embodiment of the present disclosure; and

FIG. 7 is a schematic perspective view of a plurality of high power connectors as shown in FIG. 6, in which the high power connectors are electrically connected to each other.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

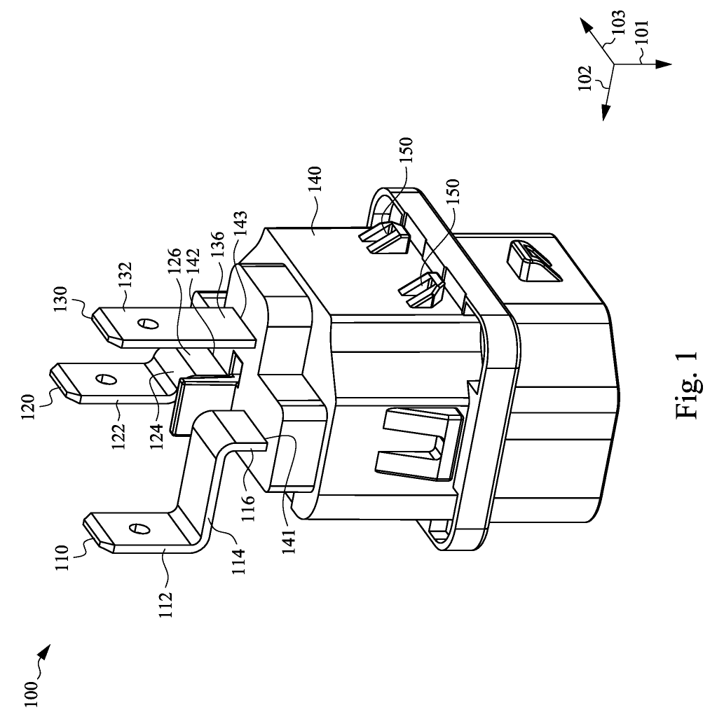

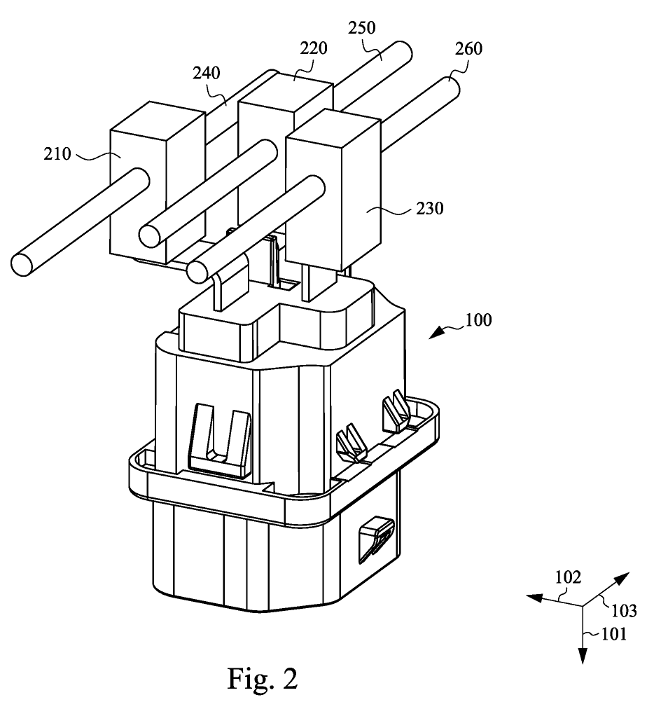

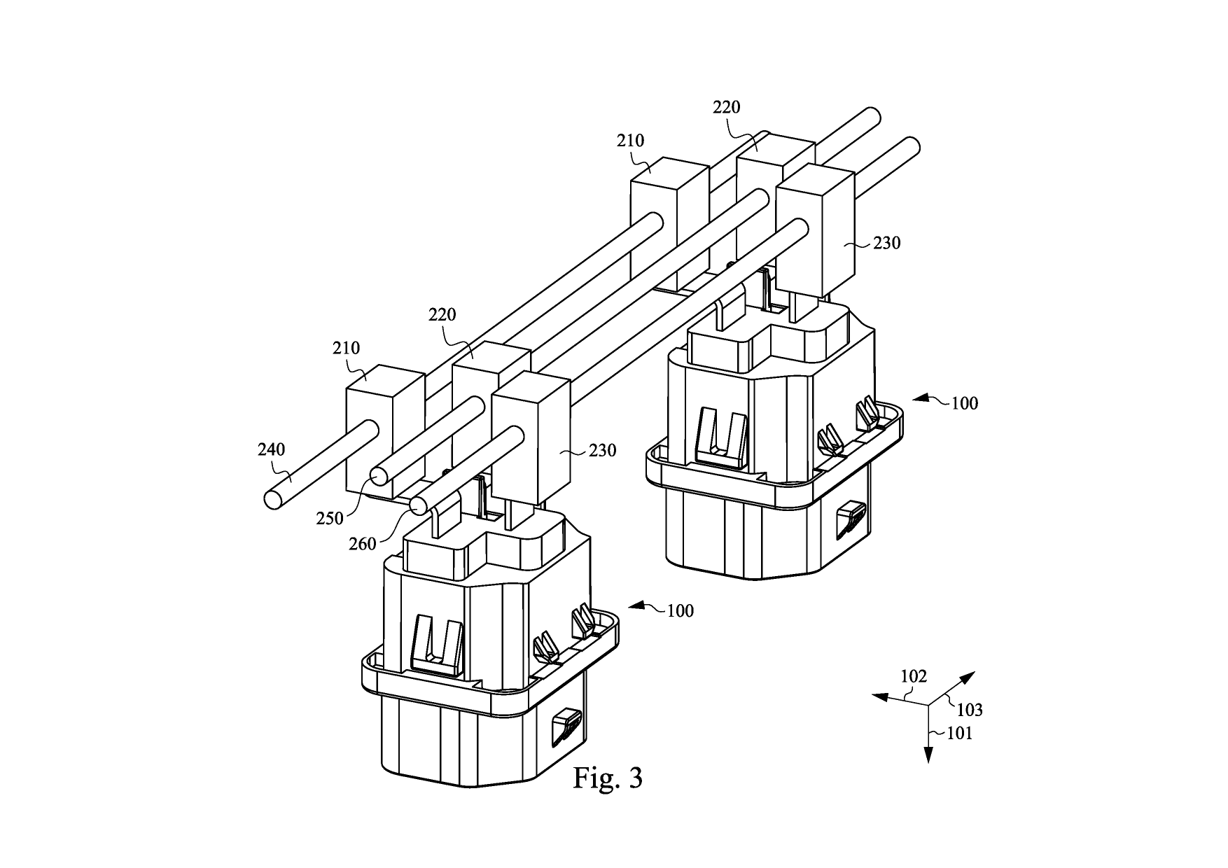

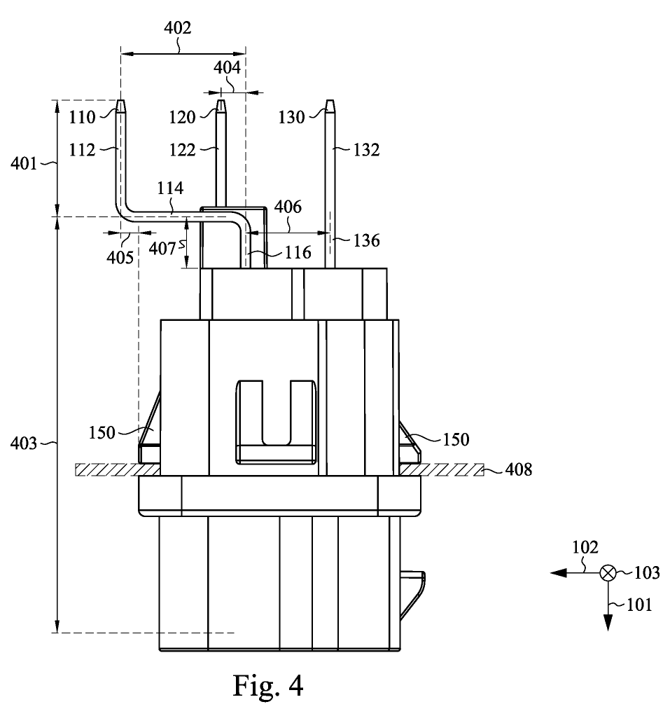

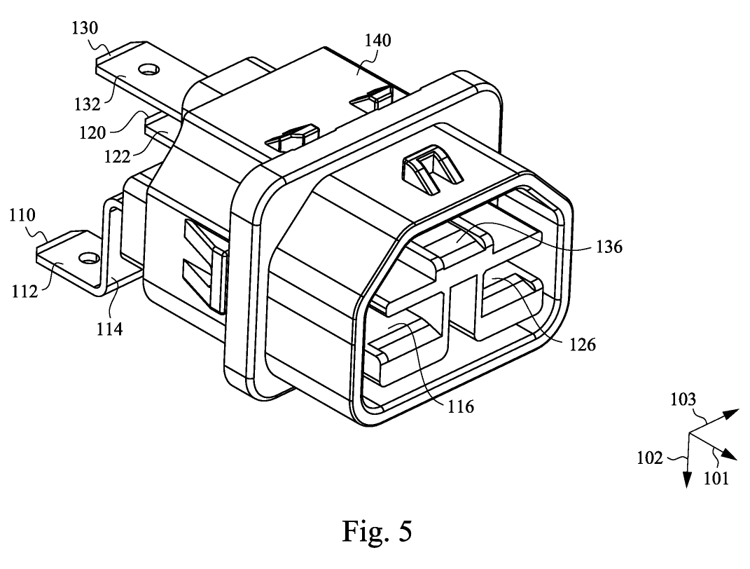

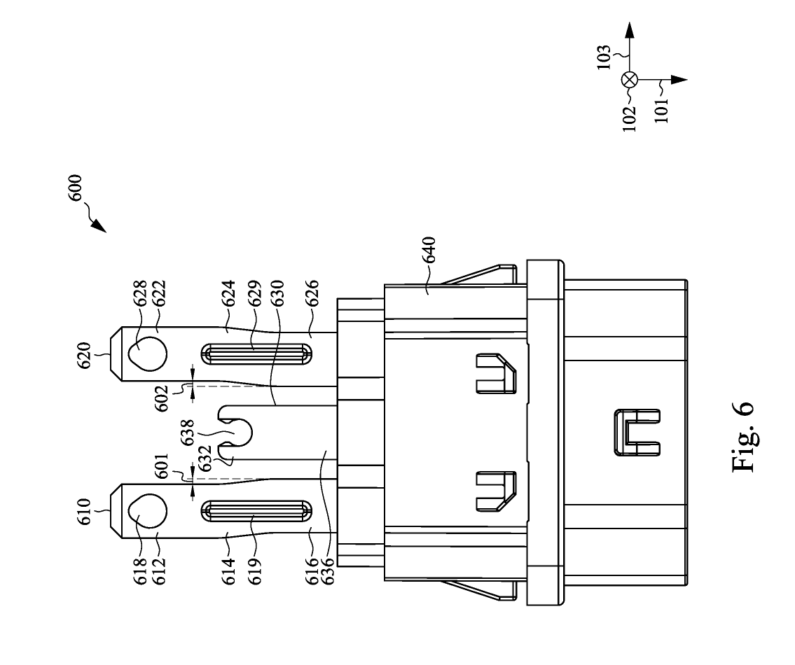

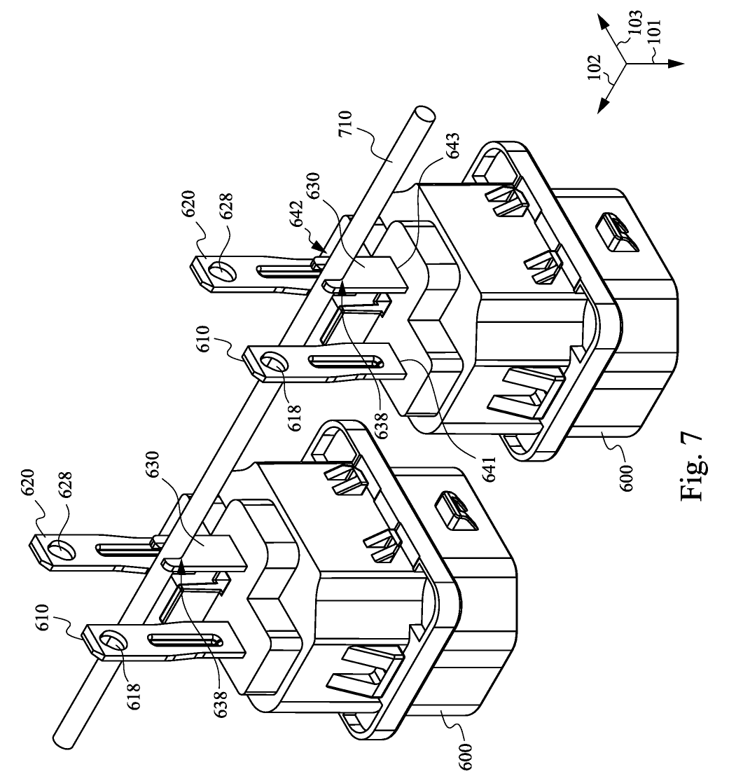

FIG. 1 illustrates a high power connector according to an embodiment of the present disclosure, FIG. 2 illustrates the high power connector connected to conductive wires through adapters, FIG. 3 illustrates a plurality of high power connectors electrically connected to each other, FIG. 4 illustrates a schematic side view of the high power connector, and FIG. 5 illustrates another schematic perspective view thereof. In addition, FIG. 6 illustrates a high power connector according to another embodiment of the present disclosure and FIG. 7 illustrates a plurality of high power connectors electrically connected to each other.

Furthermore, if the description in this specification is insufficient to explain the detailed design of the elements and makes it uneasy to implement, please take the electrical connector disclosed in the Chinese patent CN222088924U as a reference.

As shown in FIGS. 1-5, a high power connector 100 according to an embodiment of the present disclosure is provided. Moreover, for example, the high power connector 100 is utilized for electrical connection of high current.

As shown in FIGS. 1, 4 and 5, the high power connector 100 includes a housing 140, three terminals, e.g. a first terminal 110, a second terminal 120 and/or a third terminal 130. The housing 140 has a plurality of terminal holes, e.g. a first terminal hole 141, a second terminal hole 142 and/or a third terminal hole 143. The first terminal 110 includes a first head portion 116, a first connecting portion 114, and a first tail portion 112 in sequence. Similarly, the second terminal 120 includes a second head portion 126, a second connecting portion 124, and a second tail portion 122 in sequence. The third terminal 130 includes a third head portion 136 and a third tail portion 132 in sequence.

In addition, the first head portion 116 is inserted into the first terminal hole 141, the second head portion 126 is inserted into the second terminal hole 142, the third head portion 136 is inserted into the third terminal hole 143 for connecting to an external connector.

Furthermore, the first connecting portion 114 and the first tail portion 112 of the first terminal 110 are exposed from a rear side of the housing 140, and the second connecting portion 124 and the second tail portion 122 of the second terminal 120 are exposed from a rear side of the housing 140.

In some embodiments, the first terminal 110 includes a first offset distance 402 between the first tail portion 112 and the first head portion 116. In addition, the second terminal 120 includes a second offset distance 404 between the second tail portion 122 and the second head portion 126. In some embodiments, a length of the first connecting portion 114 may be equal to or greater than the first offset distance 402. In addition, a length of the second connecting portion 124 may be equal to or greater than the second offset distance 404.

In some embodiments, the third tail portion 132 of the third terminal 130 is aligned with the third head portion 136 of the third terminal 130.

It is worth noting that the first offset distance 402 is different from the second offset distance 404, and the length of the first connecting portion 114 is also different from the length of the second connecting portion 124.

In some embodiments, the third terminal 130 is a ground terminal, the first terminal 110 is a live terminal, and the second terminal 120 is a neutral terminal.

In some embodiments, the first connecting portion 114 of the first terminal 110 extends to an outside of the housing 140 along the direction 102 perpendicular to the insertion direction 101. It is worth noting that the first tail portion 112 of the first terminal 110 is located outside the housing 140 along the direction 102 perpendicular to the insertion direction 101.

In some embodiments, the first tail portion 112 of the first terminal 110 is protruded from the housing 140 along the direction 102 perpendicular to the insertion direction 101 by a protruding distance 405 of about 1-5 mm, preferably 2 mm.

In some embodiments, the first offset distance 402 is about 8-12 mm, preferably 10 mm, and the second offset distance 404 is about 1.6-2.4 mm, preferably 2 mm.

In some embodiments, a separation distance 406 between the third head portion 136 of the third terminal 130 and the first head portion 116 of the first terminal 110 is at least about 5.4-8.2 mm, preferably 6.8 mm along the direction 102 perpendicular to the insertion direction 101, and a separation distance between the third head portion 136 of the third terminal 130 and the second head portion 126 of the second terminal 120 is similar to the separation distance 406.

In some embodiments, the first head portion 116 of the first terminal 110 protrudes from the rear side of the housing 140 by a height 407 about 3.0-4.6 mm, preferably 3.8 mm, and the second head portion 126 of the second terminal 120 may also protrude from the rear side of the housing 140 about 3.0-4.6 mm, preferably 3.8 mm.

In some embodiments, the lengths 401 of the first tail portion 112 of the first terminal 110, the second tail portion 122 of the second terminal 120, the third tail portion 132 of the third terminal 130 are about 7.6-11.4 mm, preferably 9.5 mm.

In addition, the first connecting portion 114 is bent and connected to the first head portion 116 and the first tail portion 112 is bent and connected to the first connecting portion 114. In some embodiments, the first connecting portion 114 is perpendicular to the first head portion 116 and the first tail portion 112 is perpendicular to the first connecting portion 114, but not limited thereto.

In some embodiments, a total length of the first terminal 110 is a sum of lengths of the first head portion 116, the first connecting portion 114 and the first tail portion 112, and is approximately equal to the length 401 plus the first offset distance 402 and the length 403.

In some embodiments, a total length of the second terminal 120 is a sum of lengths of the second head portion 126, the second connecting portion 124, and the second tail portion 122, and is approximately equal to the length 401 plus the second offset distance 404 and the length 403.

In some embodiments, the first connecting portion 114 is longer than the second connecting portion 124, and the total length of the first terminal 110 is greater than the total length of the second terminal 120.

The high power connector 100 further includes at least one latch 150 disposed on an outer surface of the housing 140. The latch 150 is configured to engage with a corresponding recess of a mounting seat 408 to secure the high power connector 100 in place.

The latch 150 is integrally formed with the housing 140 and has a wider base portion that gradually narrows towards its top. This structural design facilitates smooth insertion into the recess of the mounting seat 408 while providing a firm locking mechanism that resists unintended disengagement. Additionally, the latch 150 is formed as a solid structure without any slots or openings, ensuring enhanced durability and mechanical strength.

Simultaneously referring to FIGS. 2 and 3, a first conductive wire 240 may be conveniently electrically connected in series to one or more first terminals 110 of the high power connectors 100 through one or more corresponding first adapters 210. Similarly, a second conductive wire 250 may be conveniently electrically connected in series to one or more second terminals 120 of the high power connectors 100 through one or more corresponding second adapters 220. In addition, a third conductive wire 260 may be conveniently electrically connected in series to one or more third terminals 130 of the high power connectors 100 through one or more corresponding third adapters 230.

Referring to FIGS. 6 and 7, a high power connector 600 according to another embodiment of the present disclosure is illustrated. The high power connector 600 includes a housing 640, three terminals, e.g. a first terminal 610, a second terminal 620 and/or a third terminal 630. The housing 640 has a plurality of through holes, e.g. a first terminal hole 641, a second terminal hole 642 and/or a third terminal hole 643. The first terminal 610 includes a first head portion 616, a first connecting portion 614, and a first tail portion 612 in sequence. Similarly, the second terminal 620 includes a second head portion 626, a second connecting portion 624, and a second tail portion 622 in sequence. The third terminal 630 includes a third head portion 636 and a third tail portion 632 in sequence.

In addition, the first head portion 616 is inserted into the first terminal hole 641, the second head portion 626 is inserted into the second terminal hole 642, and the third head portion 636 is inserted into the third terminal hole 643 for connecting to an external connector.

Furthermore, the first connecting portion 614 and the first tail portion 612 of the first terminal 610 are exposed from a rear side of the housing 640, and the second connecting portion 624 and the second tail portion 622 of the second terminal 620 are exposed from a rear side of the housing 640.

In some embodiments, the first terminal 610 includes a first offset distance 601 between the first tail portion 612 and the first head portion 616. In addition, the second terminal 620 includes a second offset distance 602 between the second tail portion 622 and the second head portion 626.

In addition, the first connecting portion 614 is connected between the first head portion 616 and the first tail portion 612, and the second connecting portion 624 is connected between the second head portion 626 and the second tail portion 622.

In some embodiments, the first connecting portion 614 is extended from the first head portion 616 and gradually extends away from the second head portion 626. The second connecting portion 624 is extended from the second head portion 626 and gradually extends away from the first head portion 616. Therefore, the first connecting portion 614 and the second connecting portion 624 form a V-shaped structure.

In some embodiments, the first offset distance 601 is equal to the second offset distance 602. For example, the first offset distance 601 and the second offset distance 602 are 0.4-0.6 mm, preferably 0.5 mm.

In some embodiments, the first head portion 616 is preferably parallel to the first tail portion 612, and the second head portion 626 is preferably parallel to the second tail portion 622.

In some embodiments, the third tail portion 632 of the third terminal 630 is aligned with the third head portion 636 of the third terminal 630.

In some embodiments, the third terminal 630 is a ground terminal, the first terminal 610 is a live terminal, and the second terminal 620 is a neutral terminal.

In some embodiments, the length of the first terminal 610 is approximately equal to the length of the second terminal 620. The length of the third terminal 630 is shorter than the length of the length of the first terminal 610.

In some embodiments, the first terminal 610 further includes an opening 618 and a reinforcement rib 619. The opening 618 is configured to electrically connect a conductive wire and the reinforcement rib 619 enhances the strength of the first terminal 610. The opening 618 is a teardrop-shaped, but not limited thereto.

In addition, the second terminal 620 further includes an opening 628 and a reinforcement rib 629. The opening 628 is configured to electrically connect a conductive wire and the reinforcement rib 629 enhances the strength of the second terminal 620. The opening 628 is a teardrop-shaped, but not limited thereto.

Furthermore, the third terminal 630 further includes a C-shaped notch 638. The C-shaped notch 638 is configured to electrically connect a conductive wire.

Simultaneously referring to FIGS. 6 and 7, a conductive wire 710 may be conveniently electrically coupled in series with the C-shaped notches 638 of one or more third terminals 630 of the high power connectors 600.

Accordingly, the high power connector according to some embodiments of the present invention can conveniently utilize in a server rack to safely provide more power with high current to the required electronic devices.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A high power connector, comprising:
a housing with a plurality of terminal holes; and
three terminals, wherein each of the three terminals is inserted into a corresponding terminal hole, wherein the three terminals respectively comprise, in sequence:
a head portion, a connecting portion, and a tail portion, wherein the head portions of the three terminals are inserted into the terminal holes for connecting to an external connector, and the connecting portions and the tail portions of the three terminals are exposed from a rear side of the housing, wherein at least one of the three terminals comprises different offset distances between the tail portions and the head portions thereof.

2. The high power connector of claim 1, wherein a first offset distance between the tail portion and the head portion of a first terminal of the three terminals is about 8-12 mm, and a second offset distance between the tail portion and the head portion of a second terminal of the three terminals is about 1.6-2.4 mm.

3. The high power connector of claim 2, wherein the tail portion of a third terminal is aligned with the head portion of the third terminal.

4. The high power connector of claim 3, wherein the connecting portion of the first terminal of the three terminals extends to an outside of the housing, and the tail portion of the first terminal of the three terminals is located outside the housing along a direction perpendicular to an insertion direction.

5. The high power connector of claim 3, wherein the third terminal is a ground terminal, the first terminal is either a live terminal or a neutral terminal, and the second terminal is correspondingly a neutral terminal or a live terminal.

6. The high power connector of claim 3, wherein a distance between the third terminal and the first terminal is at least about 5.4-8.2 mm, and a distance between the third terminal and the second terminal is at least about 5.4-8.2 mm along a direction perpendicular to an insertion direction.

7. The high power connector of claim 3, wherein the head portion of the first terminal protrudes from the rear side of the housing about 3.0-4.6 mm, and the head portion of the second terminal protrudes from the rear side of the housing about 3.0-4.6 mm.

8. The high power connector of claim 3, wherein lengths of the tail portion of the first terminal, the tail portion of the second terminal, the tail portion of the third terminal are about 7.6-11.4 mm.

9. A high power connector, comprising:
a housing with at least one through hole;
a first terminal inserted into the through hole, wherein the first terminal comprises:
a first head portion;
a first connecting portion bent and connected to the first head portion; and
a first tail portion bent and connected to the first connecting portion;
wherein a total length of the first terminal is a sum of lengths of the first head portion, the first connecting portion and the first tail portion; and
a second terminal inserted into the through hole, wherein the second terminal comprises:
a second head portion;
a second connecting portion bent and connected to the second head portion; and
a second tail portion bent and connected to the second connecting portion;
wherein a total length of the second terminal is a sum of lengths of the second head portion, the second connecting portion, and the second tail portion; and
wherein the length of the first connecting portion is greater than the length of the second connecting portion, and the total length of the first terminal is greater than the total length of the second terminal.

10. The high power connector of claim 9, wherein a first offset distance between the first tail portion and the first head portion of the first terminal is about 8-12 mm, and a second offset distance between the second tail portion and the second head portion of the second terminal is about 1.6-2.4 mm.

11. The high power connector of claim 10, further comprises a third terminal, wherein a tail portion of the third terminal is aligned with a head portion of the third terminal.

12. The high power connector of claim 11, wherein the connecting portion of the first terminal extends to an outside of the housing, and the tail portion of the first terminal is located outside the housing along a direction perpendicular to an insertion direction.

13. The high power connector of claim 11, wherein the third terminal is a ground terminal, the first terminal is a live terminal, and the second terminal is a neutral terminal.

14. The high power connector of claim 11 wherein a distance between the third terminal and the first terminal is at least about 5.4-8.2 mm, and a distance between the third terminal and the second terminal is at least about 5.4-8.2 mm along a direction perpendicular to an insertion direction.

15. The high power connector of claim 11, wherein the head portion of the first terminal protrudes from a rear side of the housing about 3.0-4.6 mm, and the head portion of the second terminal protrudes from the rear side of the housing about 3.0-4.6 mm.

16. The high power connector of claim 11, wherein lengths of the tail portion of the first terminal, the tail portion of the second terminal, the tail portion of the third terminal are about 7.6-11.4 mm.

17. The high power connector of claim 1, further comprising at least one latching protrusion disposed on an outer surface of the housing, wherein the latching protrusion is configured to engage with a corresponding recess of a mounting seat to secure the high power connector in place.

18. The high power connector of claim 17, wherein the latching protrusion has a base portion wider than its top portion and is formed without any slots or openings.
